(19) United States
(12) Patent Application Publication
(10) Pub. No.: US 2017/0115978 A1
(43) Pub. Date: Apr. 27, 2017

(54) MONITORED UPGRADES USING HEALTH INFORMATION

(71) Applicant: MICROSOFT TECHNOLOGY LICENSING, LLC, Redmond, WA (US)

(72) Inventors: Vipul A. Modi, Sammamish, WA (US); Chacko P. Daniel, Redmond, WA (US); Oana G. Platon, Redmond, WA (US); Daniel J. Mastrian, JR., Bellevue, WA (US); Todd F. Pfleiger, Seattle, WA (US); Alex Wun, Renton, WA (US); Lu Xun, Redmond, WA (US)

(21) Appl. No.: 14/923,366

(22) Filed: Oct. 26, 2015

(51) Int. Cl. G06F 9/445

(52) U.S. Cl. CPC G06F 8/65

(57) ABSTRACT

Examples of the disclosure provide for monitoring upgrades using health information. An upgrade domain includes a set of one or more nodes from a cluster of nodes. As the upgrade domain is upgraded, the health of the upgrade domain and applications hosted by nodes of the upgrade domain is monitored. Health information is received from the applications and the nodes of the upgrade domain, and is evaluated against health policies at a health check to determine if the upgrade is successful.

### BACKGROUND

Updating applications rapidly and frequently is important for developing new features and/or fixing issues with existing features. However, such updates often interfere with the availability of the application to users during the update process. Moreover, updates associated with complex applications frequently result in issues arising when something is changed. For example, upgrades may result in incompatibility between applications, as well as application features failing to work properly after an upgrade. Applications may also become unhealthy after an upgrade because of bugs in the application or due to incorrect application rollout.

In one approach, applications are upgraded during periods of low activity when unavailability of the applications will be less inconvenient to users. However, this approach provides very limited flexibility and permits low frequency of performing updates. This option does not work for applications that run twenty-four hours a day and seven days a week.

Other approaches include application swap upgrades and canary-upgrades. The application swap approach runs and tests a new version of an application alongside the current version of the application. Clients are swapped over to the new version when it is ready. However, the application swap approach requires duplicate resources and is costly. Canary-upgrades involve incrementally upgrading increasingly larger parts of an application. This approach is complex to manage and not scalable.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Examples of the disclosure provide for monitored upgrades. In one example, a cluster manager sends an application upgrade request to a first upgrade domain for upgrade of an application. The first upgrade domain includes a set of nodes from a cluster of nodes. The first upgrade domain hosts at least one instance of the application to be upgraded. The availability of the application is monitored during the upgrade. Health check results for the first upgrade domain are received from a health manager, the health manager generating the health check results based on health information received from the first upgrade domain and a set of health policies provided by the cluster manager. Based on the health check results indicating a successful upgrade, the upgrade may continue to a next upgrade domain. A failure action is performed if the upgrade is not successful.

### BRIEF DESCRIPTION OF THE DRAWINGS

FIG. 1 is an exemplary block diagram illustrating a computing environment for health monitoring during upgrades;

FIG. 2 is an exemplary block diagram illustrating a cloud computing environment for monitoring the health of an application during an upgrade;

FIG. 3 is an exemplary block diagram illustrating a computing system for monitoring upgrades of a distributed application;

FIG. 4 is an exemplary block diagram illustrating monitored upgrade for a cluster;

FIG. 5 is an exemplary block diagram illustrating an application manifest;

FIG. 6 is an exemplary block diagram illustrating health checks for monitored upgrades;

FIG. 7 is an exemplary flow diagram illustrating operation of the computing system to upgrade an application associated with an upgrade domain;

FIG. 8 is an exemplary flow diagram illustrating operation of the computing system to perform health checks during an upgrade; and

FIG. 9 is an exemplary flow diagram illustrating operation of the computing system to perform an upgrade domain health check.

### DETAILED DESCRIPTION

Referring to the figures, examples of the disclosure enable monitored rolling upgrades of cluster nodes using health information with upgrade domains to update applications while maintaining availability of the application to one or more users. In some examples, evaluating health results during upgrade operations to determine application status within a first upgrade domain increases upgrade operation speed by addressing upgrade issues at the first upgrade domain before moving on to a second upgrade domain. Application health and system health are dynamically evaluated during upgrades to identify success of the upgrade per domain, while maintaining application availability across the distributed system, for improved user efficiency and interaction with a distributed application.

Aspects of the disclosure provide for monitored upgrade using health information. The upgrade may be rolled out per upgrade domain. In other words, the upgrade is applied to one upgrade domain before applying the upgrade to the next upgrade domain. An upgrade domain includes a set of nodes within a cluster of nodes. In some examples, an upgrade domain hosts at least one instance of an application. In other examples, one upgrade domain may have certain applications or application instances while another upgrade domain has different applications or applications. In other words, an instance of an application may be present in one upgrade domain without being present in all upgrade domains, for example. Availability of the application during the upgrade is monitored automatically to generate health check results for the upgrade domain based on health information for the application instance. As used herein, automatically means acting without user input, or input of an administrator, or acting without an administrator. The monitored upgrade may be continued or rolled back based on the health check results dynamically evaluated during the upgrade. As used herein, rolled back refers to a process of returning a node, upgrade domain, cluster, or system to a previous state, such as a state that existed prior to initiating an upgrade process for example.

Aspects of the disclosure further provide a health store that persists health information associated with an upgrade domain, and a health manager that dynamically performs a health check on the upgrade domain based on the health information and a set of health policies to generate health check results. The health check results enable the cluster manager to determine the success or failure of an application upgrade, in some examples.

Examples of the disclosure further enable upgrades of large-scale, distributed applications while maintaining high availability using default system information and/or custom application health information. In some examples, the health manager leverages system and application generated health information to automatically monitor application availability. This enables more efficient upgrade processes with less application down time and improved user efficiency. The utilization of upgrade domains and health policies enable incremental upgrade to a set of nodes to respect application availability according to user-defined policies with automatic rollback in the event that issues are detected by the health check. This enables improved error detection and a reduced upgrade error rate.

In other examples, the upgrade domains enable upgrades to be performed seamlessly, in-place, without downtime and without requiring additional resources. This provides for more efficient upgrades with less resource usage. The monitored upgrades enable users to continue utilizing applications during the upgrade process without loss of availability of the application for improved user efficiency. The upgrade domains further enable more reliable and consistent user access to distributed applications both during and after the upgrade.

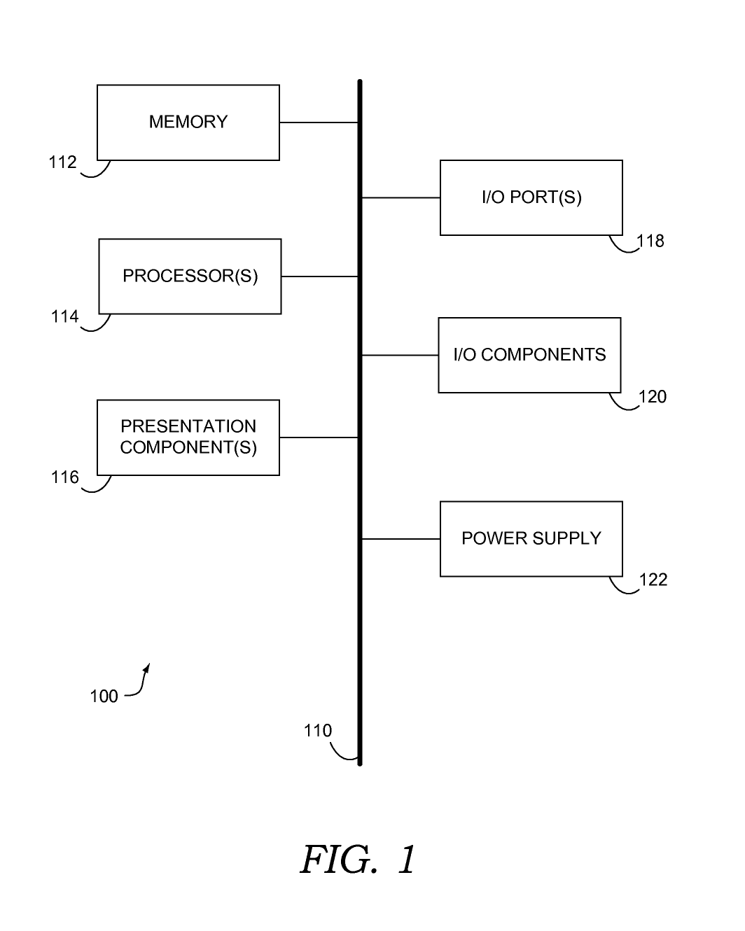

Referring to the drawings in general, and initially to FIG. 1 in particular, an exemplary operating environment for performing monitored upgrades is illustrated. Computing device 100 is one example of a suitable operating environment and is not intended to suggest any limitation as to the scope of use or functionality of the disclosure. Neither should computing device 100 be interpreted as having any dependency or requirement relating to any one or combination of components illustrated.

The disclosure may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. Examples of the disclosure may be practiced in a variety of system configurations, including hand-held devices, consumer electronics, general-purpose computers, specialty computing devices, etc. Aspects of the disclosure may also be practiced in distributed computing environments where tasks are performed by remote-processing devices that are linked through a communications network.

Computing device 100 is a system for performing monitored upgrades. In some examples, the upgrade is a cluster upgrade applied to a cluster of nodes. In other examples, the upgrade is an application upgrade. A cluster upgrade is an upgrade to one or more applications hosted on a cluster of nodes. The cluster upgrade may include an upgrade to a single application, as well as an upgrade to two or more applications running on two or more nodes within the cluster. A cluster upgrade in some examples is an upgrade to all nodes and all applications within all upgrade domains of the cluster. In other examples, a cluster upgrade is an upgrade of all applications running on nodes within one or more selected upgrade domains. In still other examples, a cluster upgrade is an upgrade to a single application running on all nodes within the cluster. An application upgrade is an upgrade to a single application running on one or more nodes. An application upgrade may be applied to a single upgrade domain, as well as two or more upgrade domains.

In some examples, the upgrade is applied to one upgrade domain at a time. When the upgrade to the first upgrade domain is complete, and is determined to be a successful upgrade, the upgrade process may be applied to the next upgrade domain. All of the upgrade domains may be upgraded by the end of the upgrade procedure if each upgrade is successful per upgrade domain.

In one example, a first upgrade domain in a cluster of nodes is updated, where the first upgrade domain includes one or more nodes from the cluster of nodes. A cluster manager automatically monitors availability of an application in the first upgrade domain during the upgrade. Health check results for the first upgrade domain are generated based on health information and a set of health policies. Based on the health check results indicating a successful upgrade of the first upgrade domain, a second upgrade domain in the cluster is then upgraded. In this manner, an application may be upgraded per upgrade domain. If the health check results indicating a failure of the upgrade for the first upgrade domain, a failure action is performed.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. Recognizing that such is the nature of the art, the diagram of FIG. 1 is merely illustrative of an exemplary computing device that may be used in connection with one or more examples of the present disclosure. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices, or any other medium that may be used to encode desired information and be accessed by computing device 100. Computer storage media does not, however, include propagated signals. Rather, computer storage media excludes propagated signals. Any such computer storage media may be part of computing device 100.

Memory 112 includes computer storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Memory 112 stores, among other data, one or more applications. The applications, when executed by the one or more processors, operate to perform functionality on the computing device. The applications may communicate with counterpart applications or services such as web services accessible via a network (not shown). For example, the applications may represent downloaded client-side applications that correspond to server-side services executing in a cloud. In some examples, aspects of the disclosure may distribute an application across a computing system, with server-side services executing in a cloud based on input and/or interaction received at client-side instances of the application. In other examples, application instances may be configured to communicate with data sources and other computing resources in a cloud during runtime, such as communicating with a cluster manager or health manager during a monitored upgrade, or may share and/or aggregate data between client-side services and cloud services.

Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

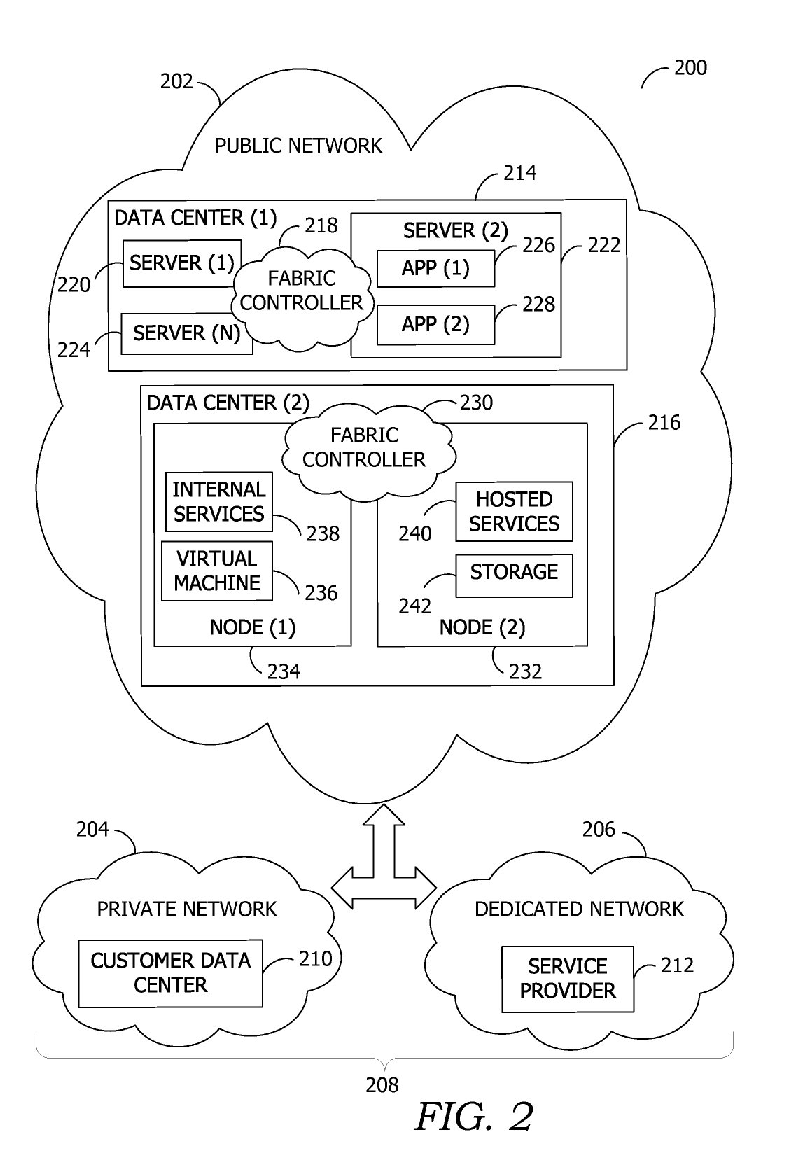

Turning now to FIG. 2, an exemplary block diagram illustrates a cloud-computing environment for monitoring the health of an application during an upgrade. Architecture 200 illustrates an exemplary cloud-computing infrastructure, suitable for use in implementing aspects of the disclosure. Architecture 200 should not be interpreted as having any dependency or requirement related to any single component or combination of components illustrated therein. In addition, any number of nodes, virtual machines, data centers, role instances, or combinations thereof may be employed to achieve the desired functionality within the scope of embodiments of the present disclosure.

The distributed computing environment of FIG. 2 includes a public network 202, a private network 204, and a dedicated network 206. Public network 202 may be a public cloud, for example. Private network 204 may be a private enterprise network or private cloud, while dedicated network 206 may be a third party network or dedicated cloud. In this example, private network 204 may host a customer data center 210, and dedicated network 206 may host an internet service provider 212. Hybrid cloud 208 may include any combination of public network 202, private network 204, and dedicated network 206. For example, dedicated network 206 may be optional, with hybrid cloud 208 comprised of public network 202 and private network 204.

Public network 202 may include data centers configured to host and support operations, including tasks of a distributed application, according to the fabric controller 218. It will be understood and appreciated that data center 214 and data center 216 shown in FIG. 2 is merely an example of one suitable implementation for accommodating one or more distributed applications and is not intended to suggest any limitation as to the scope of use or functionality of embodiments of the present disclosure. Neither should data center 214 and data center 216 be interpreted as having any dependency or requirement related to any single resource, combination of resources, combination of servers (e.g. server 220, server 222, and server 224) combination of nodes (e.g., nodes 232 and 234), or set of APIs to access the resources, servers, and/or nodes.

Data center 214 illustrates a data center comprising a plurality of servers, such as server 220, server 222, and server 224. A fabric controller 218 is responsible for automatically managing the servers and distributing tasks and other resources within the data center 214. By way of example, the fabric controller 218 may rely on a service model (e.g., designed by a customer that owns the distributed application) to provide guidance on how, where, and when to configure server 222 and how, where, and when to place application 226 and application 228 thereon. In one embodiment, one or more role instances of a distributed application, may be placed on one or more of the servers of data center 214, where the one or more role instances may represent the portions of software, component programs, or instances of roles that participate in the distributed application. In another embodiment, one or more of the role instances may represent stored data that is accessible to the distributed application.

Data center 216 illustrates a data center comprising a plurality of nodes, such as node 232 and node 234. One or more virtual machines may run on nodes of data center 216, such as virtual machine 236 of node 234 for example. Although FIG. 2 depicts a single virtual node on a single node of data center 216, any number of virtual nodes may be implemented on any number of nodes of the data center in accordance with illustrative embodiments of the disclosure. Generally, virtual machine 236 is allocated to role instances of a distributed application, or service application, based on demands (e.g., amount of processing load) placed on the distributed application. As used herein, the phrase “virtual machine” is not meant to be limiting, and may refer to any software, application, operating system, or program that is executed by a processing unit to underlie the functionality of the role instances allocated thereto. Further, the virtual machine 236 may include processing capacity, storage locations, and other assets within the data center 216 to properly support the allocated role instances.

In operation, the virtual machines are dynamically assigned resources on a first node and second node of the data center, and endpoints (e.g., the role instances) are dynamically placed on the virtual machines to satisfy the current processing load. In one instance, a fabric controller 230 is responsible for automatically managing the virtual machines running on the nodes of data center 216 and for placing the role instances and other resources (e.g., software components) within the data center 216. By way of example, the fabric controller 230 may rely on a service model (e.g., designed by a customer that owns the service application) to provide guidance on how, where, and when to configure the virtual machines, such as virtual machine 236, and how, where, and when to place the role instances thereon.

As discussed above, the virtual machines may be dynamically established and configured within one or more nodes of a data center. As illustrated herein, node 232 and node 234 may be any form of computing devices, such as, for example, a personal computer, a desktop computer, a laptop computer, a mobile device, a consumer electronic device, server(s), the computing device 100 of FIG. 1, and the like. In one instance, the nodes host and support the operations of the virtual machines, while simultaneously hosting other virtual machines carved out for supporting other tenants of the data center 216, such as internal services 238 and hosted services 240. Often, the role instances may include endpoints of distinct service applications owned by different customers.

Typically, each of the nodes include, or is linked to, some form of a computing unit (e.g., central processing unit, microprocessor, etc.) to support operations of the component(s) running thereon. As utilized herein, the phrase “computing unit” generally refers to a dedicated computing device with processing power and storage memory, which supports operating software that underlies the execution of software, applications, and computer programs thereon. In one instance, the computing unit is configured with tangible hardware elements, or machines, that are integral, or operably coupled, to the nodes to enable each device to perform a variety of processes and operations. In another instance, the computing unit may encompass a processor (not shown) coupled to the computer-readable medium (e.g., computer storage media and communication media) accommodated by each of the nodes.

The role instances that reside on the nodes support operation of service applications, and may be interconnected via application programming interfaces (APIs). In one instance, one or more of these interconnections may be established via a network cloud, such as public network 202. The network cloud serves to interconnect resources, such as the role instances, which may be distributably placed across various physical hosts, such as nodes 232 and 234. In addition, the network cloud facilitates communication over channels connecting the role instances of the service applications running in the data center 216. By way of example, the network cloud may include, without limitation, one or more local area networks (LANs) and/or wide area networks (WANs). Such networking environments are commonplace in offices, enterprise-wide computer networks, intranets, and the Internet. Accordingly, the network is not further described herein.

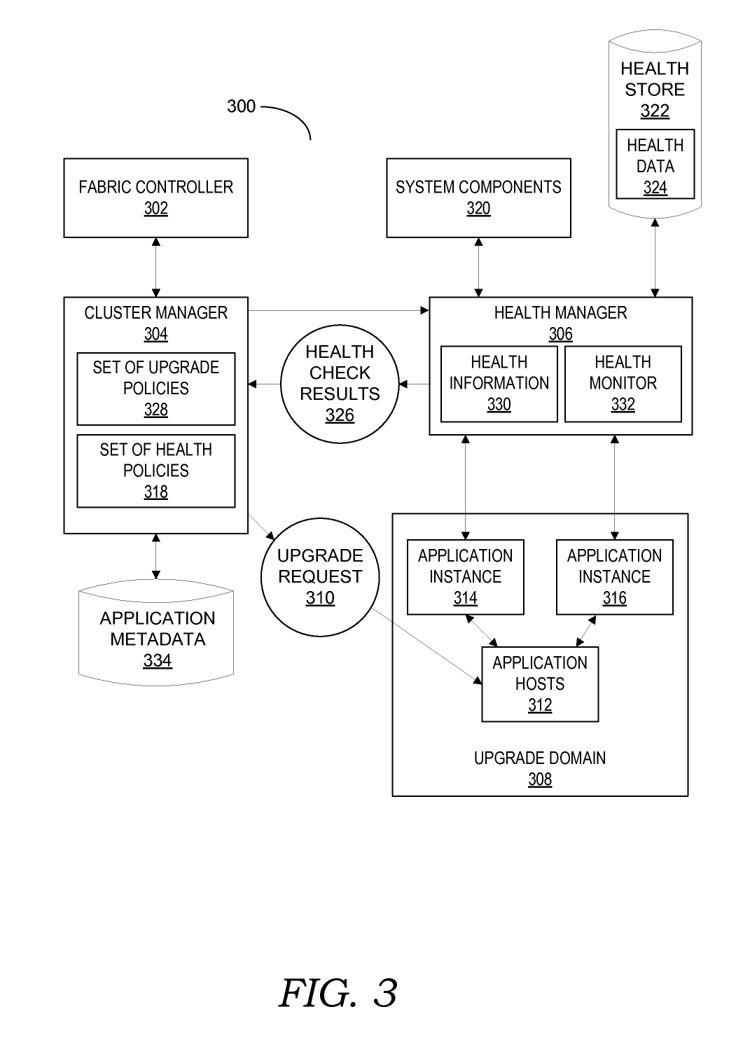

FIG. 3 is an exemplary block diagram of a computing system for monitoring upgrades. Computing system 300 may be an exemplary illustration of one implementation of computing device 100 in FIG. 1, for example. Computing system 300 is a system for performing monitored upgrades of distributed applications using health information to ensure successful upgrades of applications while maintaining availability of the application to users. Computing system 300 may be implemented on a public cloud, a private cloud, a hybrid public and private cloud, a distributed computing system or any other type of system including a plurality of nodes hosting application instances.

A fabric controller 302 hosts a cluster manager 304, a health manager 306, and a set of nodes within an upgrade domain 308. In this illustration a single upgrade domain is shown. However, computing system 300 may include a plurality of upgrade domains, with each upgrade domain including a set of nodes.

In a monitored rolling application upgrade, the fabric controller 302 monitors the health of the application being upgraded based on a set of health policies 318. When the applications in an upgrade domain 308 have been upgraded, the fabric controller 302 evaluates the application health and determines whether to proceed to the next upgrade domain or fail the upgrade based on the health policies.

In this example, an application instance is created, upgraded, or deleted by computing system 300. The cluster manager 304 manages the application instances associated with computing system 300. Computing system 300 may include multiple instances of one or more applications. The application instances are implemented on the service fabric, or virtualization management layer, as illustrated by fabric controller 302.

The cluster manager 304 sends an upgrade request 310 to application hosts 312 to initiate an upgrade of one or more applications associated with the upgrade domain 308 being upgraded. The upgrade domain 308 in this example includes application instance 314 and application instance 316. The upgrade in this example is an upgrade of application instances 314 and 316 from a first version of the application to a second version of the application. On completion of the upgrade, the cluster manager 304 optionally waits for a period of time, such as a health check wait time, prior to initiating a health check.

The health check wait time is an upgrade parameter. Upgrade parameters include rules for guiding, controlling, and managing an application upgrade and/or a cluster upgrade process. In this example, a set of upgrade policies includes one or more upgrade parameters associated with upgrading a particular application. The set of upgrade policies 328 optionally overrides application default policies.

Examples of upgrade parameters include the health check wait time, retry time out period, a consider warning error parameter, a max percent unhealthy deployed applications parameter, max percent unhealthy services parameter, a max percent unhealthy partitions parameter, and/or a max percent unhealthy replicas per partition parameter, and/or any other parameters for monitoring the upgrade process.

In some examples, the upgrade parameters may be predetermined default parameters or user defined parameters. In other examples, the upgrade parameters are updated by the user during the upgrade process. The upgrade parameters may be passed in configuration but may be overridden in the application programming interface (API) both at the beginning of the upgrade and during the upgrade updates.

The health check wait time is an upgrade parameter specifying a period of time to wait after an upgrade of an entire upgrade domain completes before the health manager 306 evaluates the health of the application on the upgrade domain. In other words, after all instances of the application within a particular upgrade domain have completed upgrading, computing system 300 waits the health check wait time before performing the health check to determine if the upgrade completed successfully. If the health check passes, the upgrade process proceeds to the next upgrade domain. If the health check fails, the upgrade process waits a retry time out period before retrying the health check again.

In some examples, the health check wait time is a pre-configured or predetermined period of time. The health check wait time may be a default wait time or a user selected wait time. In other examples, the health check wait time is updated after the upgrade begins. In other words, a user may select to change the health check wait time during the upgrade process.

The cluster manager 304 enforces the set of health policies 318 and passes them on to the health manager 306 for evaluation. The cluster manager 304 evaluates the health of the application through the health check results 326 received from health manager 306. The health check results 326 may be reported on the application being upgraded as well as the overall health of the services for the application, and the health of the application hosts 312 and/or computing systems associated with the application being upgraded. The health of the application services is evaluated by aggregating the health of their children such as the service replica. A replica is a copy of the original on a different node. Replica health is rolled into the partition health and the partition health is rolled into the service health and subsequently rolled into the overall application instance health. Once the application health policy is satisfied, the upgrade proceeds. However, if the health policy is violated the application upgrade fails.

In this example, the cluster manager 304 sends a set of health policies 318 to the health manager 306 to initiate the health check. The cluster manager forwards this health policy information to the health manager for each application being upgraded. The set of health policies 318 includes criteria for the health evaluation. The criteria are upgrade parameters for the health policy identifying rules and/or checks applied at each health check interval.

In some examples, the set of health policies 318 includes health check parameters such as, but not limited to, the health check wait time, a consider warning as error parameter, a max percent unhealthy deployed applications parameter, a max percent unhealthy services parameter, a max percent unhealthy partitions parameter, and/or a max percent unhealthy replicas per partition parameter. The parameter for “consider warning as error” is a parameter to treat warning health events for the application as error when evaluating the health of the application during upgrade. By default, computing system 300 does not evaluate warning health events to be a failure (error), so the upgrade is permitted to proceed even if there are warning events.

The max percent unhealthy deployed applications parameter specifies a maximum number of deployed applications that are permitted to be unhealthy before the application is consider unhealthy and fail the upgrade. This is the health of the application package that is on the node, hence this is useful to detect immediate issue during upgrade and where the application package deployed on the node is unhealthy (crashing, etc. . . . ). In a typical case, the replicas of the application are load balanced to the other node, making the application appear healthy, thus allowing upgrade to proceed. By specifying a max percent unhealthy deployed applications parameter for health, the computing system 300 detects a problem with the application package quickly, which results in a fail fast upgrade.

The max percent unhealthy service parameter specifies the maximum number of services in the application instance that are allowed to be unhealthy before the application is considered unhealthy and the upgrade is failed. The max percent unhealthy partitions parameter specifies the maximum number of partitions in a service permitted to be unhealthy before the service is considered unhealthy. The max percent unhealthy replicas per partition parameter specify the maximum number of replicas in partition that are unhealthy before the partition is consider unhealthy.

The health manager 306 monitors system health and application health. The nodes and applications send reports including health information 330 to the health manager 306. In this example, the health manager 306 obtains health information 330 associated with the application upgrade. The health information 330 includes system health information and/or application health information. In other words, the health information 330 includes configuration data and/or performance data for one or more components and/or applications. The health information 330 may describe components, systems, the machines that applications and software components run on, or any other systems or applications information.

The health manager 306 optionally includes a health monitor 332. The health monitor is a component that receives health information associated with the application and/or other system components of the upgrade domain from watchdogs and the other reporters associated with the system components. The health monitor may send requests for health information to the application hosts 312 and/or other system component reporters. Health monitor 332 may gather information and send requests for information dynamically and/or periodically.

In this example, the system components 320 send system health information to the health manager 306. The system components 320 include the hardware and/or software components associated with the upgrade domain 308. In this example, the system components include the nodes, input output devices, processor(s), network interface devices, and any other hardware and/or software components. The system health information includes information describing the performance and/or configuration of the system components.

The application also sends application health information to the health manager 306. In this example, the application instances 314 and 316 send the application health information to the health manager 306.

The health manager 306 evaluates the health information received, from application instances 314 and 316 as well as the health information received from system components, based on the set of health policies 318. The set of health policies 318 includes one or more policies regarding health of an application. In this example, the set of health policies 318 may be a set of policies for a specific application.

The set of health policies 318 may be a set of user defined policies, in some examples. If the health check results indicate that an upgrade failed, the user may have the health re-checked. In other examples, the set of health policies 318 may include system-defined policies, application-designed policies, enterprise-defined policies, or any other suitable health policies.

In some examples, the user dynamically modifies one or more rules in the set of health policies to create a second set of health policies. The second set of health policies is applied to the health information to determine if the upgrade passes or fails. In other words, if an upgrade fails because of one or more policies in the set of health policies 318, a user may optionally change the one or more policies to permit the upgrade to pass.

In some examples, the first set of health policies, the second set of health policies, the health information, and/or the health check results 326 may be saved in a health store 322 as health data 324. The health store 322 may be implemented as any type of data storage, such as data storage device, a data structure, a database, or any other data store. The health manager 306 sends the health check results 326 to the cluster manager 304. In this manner, health data 324 is persisted in health store 322, managed by the health manager 306.

The health data 324 includes any type of health information, such as, but not limited to, information about the application, application instances running on this particular upgrade domain, application health, health check results, information about each instance of the application, information about a distributed application, etc. The health manager collects, collates, stores, and evaluates the health information 330. In this manner, the health manager performs computation of an aggregated health state for both system components and user components.

The cluster manager 304 determines if the upgrade to the upgrade domain 308 is successful or unsuccessful based on the health check results 326. An unsuccessful upgrade is an upgrade that fails based on the health check results and/or one or more of the upgrade parameters. In some examples, the cluster manager 304 determines if the upgrade is a success or failure based on the health check results 326 and/or a set of health policies 318.

If an upgrade is determined to be successful, the cluster manager 304 determines what to do next based on the set of upgrade policies 328. The set of upgrade policies 328 in this example may be user generated policies created by one or more users. In some examples, the set of upgrade polices is specified by an administrator for a specific application. In other words, the set of upgrade policies are specific to one particular application. In these examples, each application includes its own set of upgrade policies.

In this non-limiting example, the set of upgrade policies 328 includes a set of upgrade success actions. For example, the set of upgrade policies 328 may include polices for determining whether to continue upgrading the next upgrade domain, whether to upgrade an intermediate version to a final version of the application, whether to stop upgrading until a user permission is received, and/or whether to send an upgrade status to a user indicating that the upgrade completed successfully.

The set of upgrade policies 328 may also include a set of upgrade failure actions. A failure action is an action to be taken by the cluster manager and/or the fabric controller if an upgrade fails based on user-defined policies, such as those in the set of upgrade policies. An upgrade failure action may include sending an upgrade status to a user indicating failure of the upgrade, automatic rollback to a previous version of the application without user intervention; continue upgrade to the next upgrade domain, retry the health check after a wait time, suspend the application upgrade at the current upgrade domain, allow manual intervention, and so forth. After manual intervention by a user, or other entity having permission, chooses whether to continue the upgrade manually, one upgrade domain at a time; restart the automatic rollback to the previous version; resume the monitored upgrade with a new set of health policies; or skip the current upgrade domain and continue the upgrade with the next upgrade domain. After manual intervention, a component such as an application programming interface (API) or other entity with permission determines the action to be taken after the failed upgrade on the current upgrade domain.

If the action taken after the failed upgrade includes retrying the health check, the health check is performed again until a successful upgrade is achieved or until a health check retry timeout is reached. In other words, the health check retry timeout is the maximum duration of time the health manager 306 continues to retry failed health evaluations before the cluster manager 304 declares the upgrade as failed. This duration starts after the health check wait time expires. During the health check retry timeout period, the health manager 306 performs one or more re-try health checks of the application health until the upgrade completes successfully or until the retry time expires.

An upgrade timeout is a maximum amount of time for the overall upgrade to all nodes across all upgrade domains to complete. In some examples, the upgrade timeout is the amount of time permitted for the upgrade to the entire cluster. If the upgrade to all nodes in the cluster is not complete when the upgrade timeout expires, the upgrade stops and a failure action triggers.

An upgrade domain timeout is a maximum amount of time for upgrading a given upgrade domain. When the upgrade domain timeout expires, the upgrade of the given upgrade domain stops and the failure action is triggered.

An upgrade is a success if no health issues are detected. The health issues may include compatibility issues with other applications and/or application instances, the upgraded application(s) functioning improperly, and/or the application(s) otherwise unavailable for utilization.

A health check stable duration is an amount of time to wait while verifying that the application is stable before moving to the next upgrade domain or completing the upgrade process. This wait duration is used to prevent undetected changes of health right after the health check is performed.

The cluster manager 304 optionally saves application metadata 334 in data storage. The data storage may be any type of data storage, such as data storage device, a data structure, a database, or any other data store. Upon completion of a successful upgrade to the upgrade domain 308, the cluster manager 304 determines if there is a next upgrade domain to be upgraded. If there is another upgrade domain running instances of the application that have not yet been upgraded to the new version of the application, the cluster manager 304 initiates the upgrade on this next upgrade domain by sending the upgrade request 310 to the next upgrade domain. This process continues until all instances of the application have been upgraded.

In this example, the cluster manager provides a status update for the upgrade to the user at one or more points during the upgrade process. In some examples, the cluster manager provides the upgrade status indicating if the upgrade is a success or a failure at the completion of the upgrade process. In other examples, the cluster manager provides an update status indicating the upgrade is being initiated, in progress, performing a health check, completed, successfully completed, or the upgrade failed at any point during the upgrade.

The user may optionally request the upgrade status from the cluster manager at any point during the upgrade process. In some examples, the upgrade status is preserved even after the upgrade completes. In these examples, if an upgrade fails and/or a rollback happens, the user may retrieve the upgrade status and determine why the rollback occurred based on the saved upgrade status data.

The upgrade workflow of each application instance is driven independently, allowing for concurrent upgrades across different application instances and versions. The cluster manager combines the application upgrade state with the health check results to drive the upgrade workflow through other system components responsible for hosting application instances associated with the cluster.

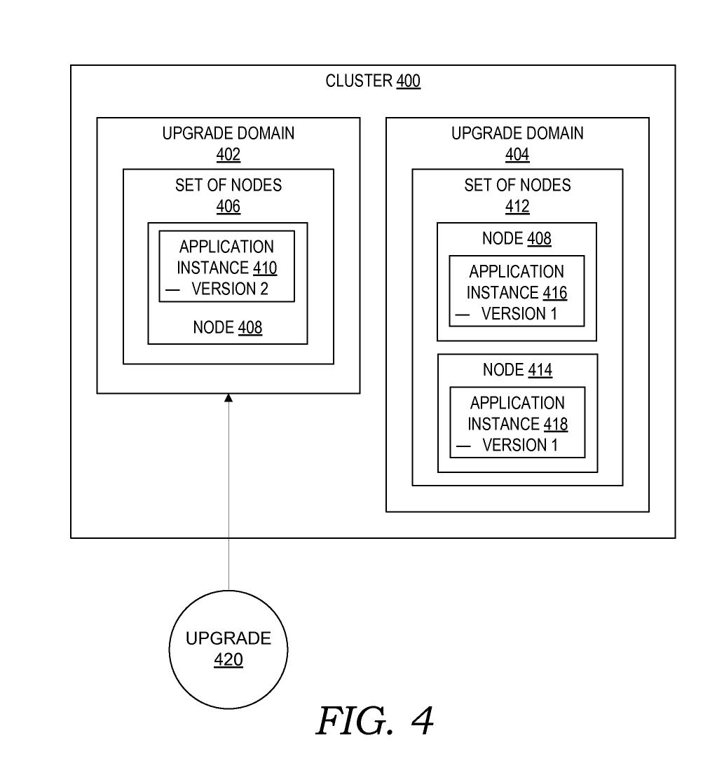

FIG. 4 is an exemplary block diagram illustrating a cluster that may be updated with a monitored update. A cluster 400 is a computer cluster including two or more nodes. The nodes are configured into upgrade domains. In this example, the upgrade is performed in a monitored rolling upgrade.

In a rolling application upgrade, the upgrade is performed in stages. At each stage, the upgrade is applied to a subset of nodes in the cluster, called an upgrade domain, such as upgrade domain 402 and upgrade domain 404. As a result, the application being upgraded remains available throughout the upgrade process.

During the upgrade, the cluster 400 may contain a mix of the old and new versions. For that reason, the two versions must be forward and backward compatible. If they are not compatible, the application is upgraded in a multiple-phase upgrade to maintain availability. This is done by performing an upgrade with an intermediate version of the application that is compatible with the previous version before upgrading to the final version. Upgrade domains may be specified when configuring the cluster.

During an application upgrade, the application instances on the nodes in a given upgrade domain may be upgraded together, or all application instances running on nodes within the cluster may be upgraded together. During a cluster upgrade, the nodes in a given upgrade domain may be upgraded together as a unit. However, the nodes in other upgrade domains are not upgraded together with the nodes in the given upgrade domain. In other words, the nodes in a first upgrade domain are upgraded together before the upgrade is applied to any of the nodes in a second or other upgrade domain. The nodes in other upgrade domains are not upgraded until the upgrade to the first upgrade domain completes successfully.

As one example, an upgrade 420 may be performed on an application instance 410 hosted on node 408 of a set of nodes 406 in upgrade domain 402. However, the upgrade 420 is not applied to the one or more applications running on a set of nodes 412 within the other upgrade domain 404. In this manner, the application instances 416 and 418 running on upgrade domain 404 remain available to users while the application instance 410 is being upgraded on upgrade domain 402. Only the applications running on the upgrade domain 402 are down or unavailable during the upgrade process.

During the monitored upgrade process, some nodes may be running an older version of an application while other nodes are running the already upgraded, newer version of the application. In this example, upon completion of the upgrade 420, the upgrade domain 402 is running application 410 upgraded to a new version “2”. However, because the upgrade 420 has not yet been applied to upgrade domain 404, node 408 and node 414 are running application instances 416 and 418 corresponding to the older version “1” of the application.

When the upgrade 420 is complete and the health check results indicate a successful completion of the upgrade, the upgrade 420 is applied to upgrade domain 404 to upgrade the application instances 416 and 418 from the old version “1” to the new version “2” of the application. During this next upgrade of upgrade domain 404, the application instance 410 continues running and remains available to users during the upgrade of set of nodes 412.

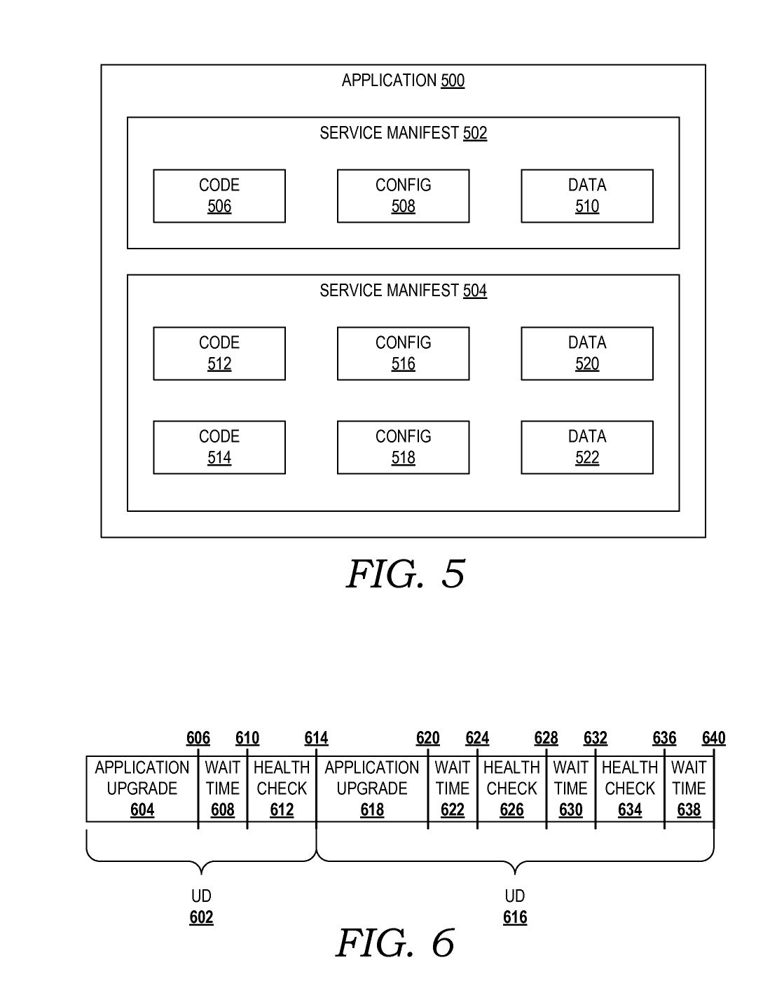

FIG. 5 is an exemplary block diagram illustrating an application manifest. An application 500 is any type of application running on a node. The application 500 includes a set of one or more service manifests. A service manifest is a manifest file representing a service provided by the application 500, such as service manifest 502 and 504. However, the examples are not limited to two service manifests. An application contains one or more service manifests. In some examples, the application contains a single service manifest, while in other examples the application may contain two or more service manifests.

A service manifest 502 includes code 506, configuration 508, and data 510. A service manifest may include multiple sets of code, configuration information, and data. For example, the service manifest 504 includes code 512 and code 514, configuration 516 and configuration 518, and data 520 and data 522.

Each unit shown in FIG. 5 is an independent unit of upgrade. Units that have not been changed are unaffected by the upgrade at runtime. In other words, an upgrade to the configuration 508 associated with service manifest 502 does not impact service manifest 504. The services associated with service manifest 504 remain available to users during the upgrade(s) to the configuration 508 associated with service manifest 502.

The replicas and application instances continue to run during the upgrade process. This provides upgrade granularity within a single application manifest version and across versions. Multiple simultaneous rolling upgrades are performed with independent workflows for each workflow.

FIG. 6 is an exemplary block diagram illustrating health checks for monitored upgrades. As used herein, an upgrade domain is a set of one or more nodes within a cluster of nodes on a distributed computing system. A cluster of nodes may be configured into one or more upgrade domains, such that upgrade of one domain does not affect application availability or services distributed across the cluster of nodes, for example. Upgrade domain 602 may include a single instance of an application or multiple instances of an application. In this non-limiting example, one or more other upgrade domains may include one or more other instances of the application. During the upgrade to the application associated with upgrade domain 602, the application continues to run and remains available for utilization on the one or more other upgrade domains, such as upgrade domain 616.

The application upgrade 604 is applied to the application instances associated with the set of nodes within upgrade domain 602. At upgrade completion 606, the cluster manager pauses for a health check wait time 608. When the wait time has completed 610, the cluster manager initiates a health check 612 of the upgrade domain 602. In some examples, the health check initiated by the cluster manager is sent as a health check request to the health manager. The health manager uses the set of health policies provide by the cluster manager or the application being upgraded and evaluates the health information received from the upgrade domain against the set of health policies to generate the health check results. The health manager returns the health check results to the cluster manager. If the health check results 614 indicate the upgrade completed successfully, the cluster manager determines if there is a next upgrade domain to be upgraded.

In this example, the next upgrade domain to be upgraded is upgrade domain 616. The cluster manager sends an upgrade request for application upgrade 618 to upgrade domain 616. In some examples, the application upgrade 618 may be the exact same upgrade as application upgrade 604, such as an upgrade of the application to the same new version of the application. In other examples, the application upgrade 618 may be a different upgrade to a different version of the application or an upgrade of a different application. As one example, the application upgrade 604 may be an upgrade of an application from an old version to a new version, while the application upgrade 618 may be a multiple phase upgrade. The multiple phase upgrade, in one example, is an upgrade from the old version to an intermediate version which is then followed by another upgrade from the intermediate version to the new (final) version of the application.

On upgrade completion 620 of the application upgrade 618, the cluster manager pauses for the health check wait time 622. At the wait time completion 624 of the health check wait time, the cluster manager requests a health check 626 on the upgrade domain 616. If the received health check results 628 indicate the health check failed, based on the set of health policies, the cluster manager determines if the heath check retry timeout has not yet expired. Upon determining that the health check retry timeout has not expired, the cluster manager waits the health check wait time 630, and at wait time completion 632 the cluster manager initiates another (second) health check 634. If the received second health check results 636 of the upgrade domain 616 also fails and the health check retry timeout has still not expired, the cluster manager pauses for the health check wait time 638, and at wait time completion 640 may initiate a third health check of the upgrade domain 616. The cluster manager may iteratively perform health checks of the upgrade domain during the health check retry timeout period. When the health check retry timeout expires, the cluster manager stops performing health checks and performs an upgrade failure action, such as indicating failure of the upgrade to the upgrade domain 616.

In some examples, the upgrade failure action includes automatically rolling back the application to the previous version, failing the upgrade to upgrade domain 616 but continuing the upgrade process with a next (third) upgrade domain, ceasing all upgrades to all upgrade domains pending a user selection to continue the upgrade process on a next upgrade domain, notifying a user of the upgrade failure, requesting a user manually select an upgrade failure action to be taken, resume the monitored upgrade with a new (revised) set of health policies, or any other suitable upgrade failure action.

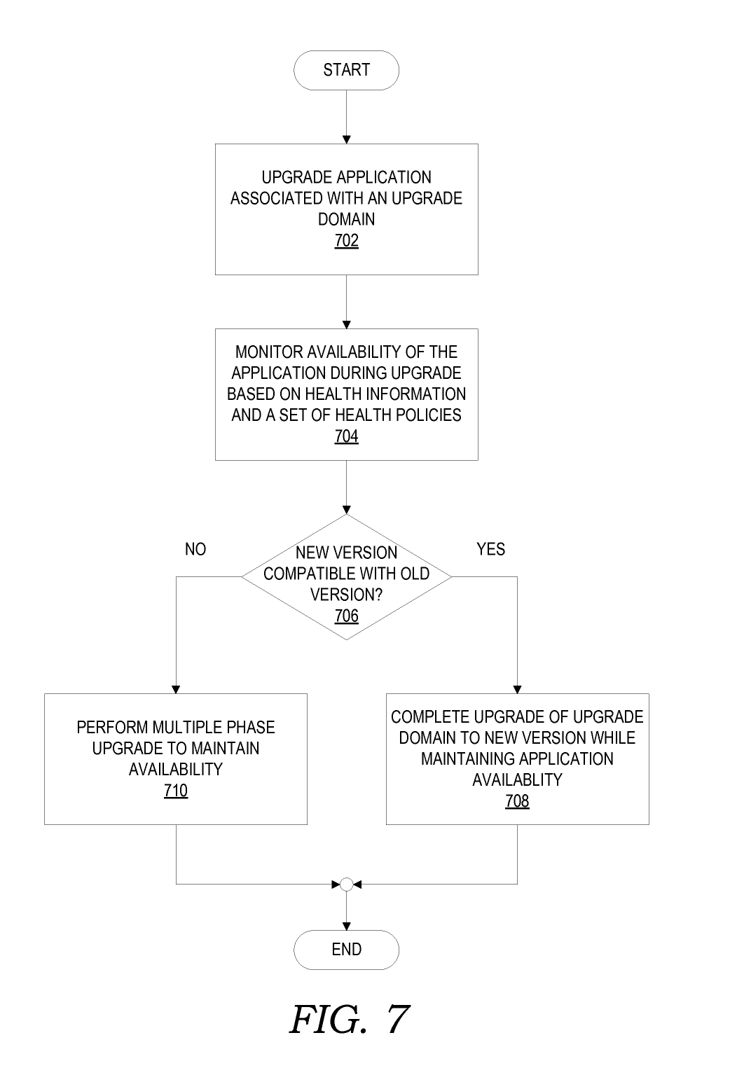

FIG. 7 is an exemplary flow diagram of operations for upgrading an application associated with an upgrade domain. An application associated with an upgrade domain is upgraded at operation 702. The cluster manager monitors availability of the application during upgrade based on health information and a set of health policies at operation 704. A determination is made as to whether a new version of the application is compatible with the old version of the application at operation 706. If the new version is compatible, the upgrade to the new version of the application is completed while maintaining application availability at operation 708. The process then terminates.

If the new version of the application is not compatible with the old version of the application, a multiple phase upgrade may be performed at operation 710. The multiple phase upgrade involves upgrading to an intermediate version of the application that is compatible with both the old version and the new version of the application. After completion of the multiple phase upgrade, the process terminates.

In this example, if a new version of the application is not compatible with the old version of the application running on a different node within the upgrade domain, the health check results may indicate an unsuccessful upgrade, which triggers a failure action. If a failure action triggers due to incompatibility issues between application versions, for example, an administrator may initiate a multiple phase upgrade to ensure that each version of the application is backwards compatible with a previous version, until a final version of the upgraded application is achieved. In other examples, the upgrade to a new version of the application may be successful, with subsequent incompatibility issues arising that result in the application becoming unhealthy of having undefined application behavior at a future time.

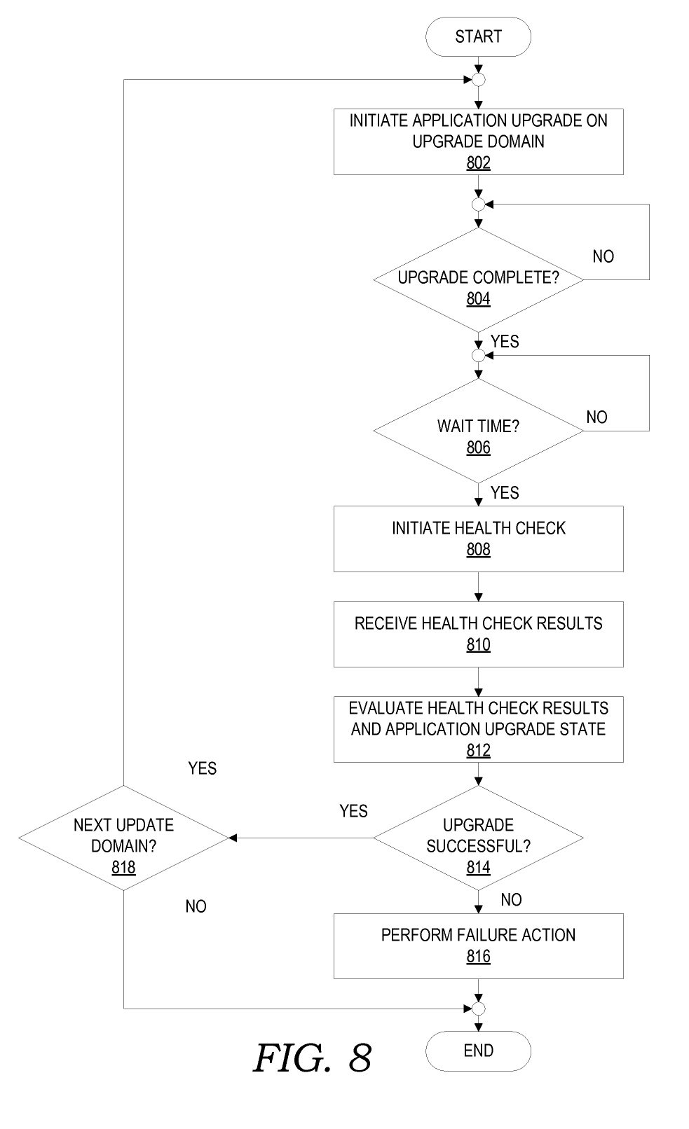

FIG. 8 is an exemplary flow diagram of operations for health checks during an upgrade. An application upgrade on an upgrade domain is initiated by a cluster manager at operation 802. A determination is made as to whether the upgrade is complete at operation 804. If the upgrade is not complete, the cluster manager continues to monitor the upgrade until the upgrade has completed. If the upgrade is complete, a determination is made as to whether the health check wait time has passed at operation 806. If the health check wait time has not passed, the cluster manager continues to monitor the upgrade. If the health check wait time is passed, the cluster manager initiates a health check at operation 808. The health check results are received at operation 810. The health check results and an application upgrade state are evaluated at operation 812.

A determination is made as to whether the upgrade is successful at operation 814. The determination is made based on the health check results and/or application state data. If the upgrade is not successful, a failure action is performed at operation 816. If the upgrade is successful at operation 814, a determination is made as to whether there is a next upgrade domain to be updated at operation 818. If a determination is made that there is a next upgrade domain to be updated, the process returns to operation 802. If there are no update domains to be updated at operation 818, the process terminates.

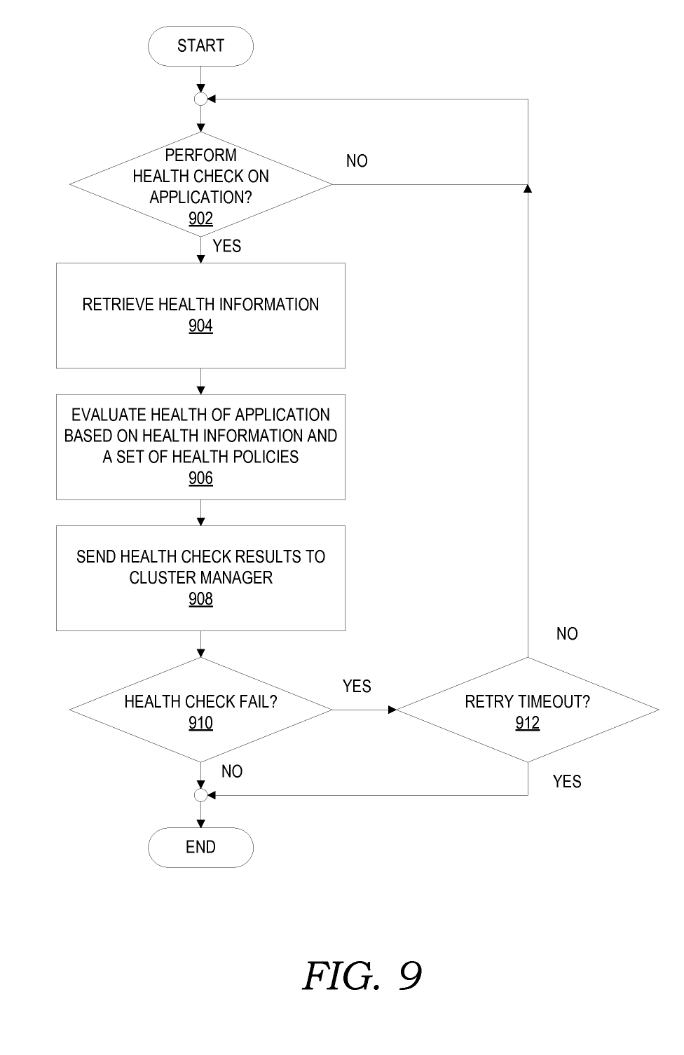

Turning now to FIG. 9, an exemplary flow diagram illustrates operations for domain health checks during monitored upgrades. The operations illustrated in FIG. 9 are performed by a monitored upgrade system, such as computing system 300 in FIG. 3, for example. The system determines whether a health manager component is to perform a health check on an application at operation 902. If a health check is not being performed, the process returns to operation 902 until a health check is to be performed.

When a health check is performed at operation 902, health information is retrieved at operation 904. The health information includes system health information and/or application health information. The health of the application is evaluated based on health information and a set of health policies at operation 906. The health check results are sent to a cluster manager at operation 908. If the health check results indicate the health check did not fail, the process terminates.

If the health check results indicate the health check fails at operation 910, a determination is made as to whether a retry timeout has been reached. If not, the process returns to operation 902 and performs another health check on the application. If the retry timeout has been reached at operation 912, the process terminates, and the system may perform a failure action.

The present disclosure has been described in relation to particular examples, which are intended in all respects to be illustrative rather than restrictive. Alternative examples will become apparent to those of ordinary skill in the art to which the present disclosure pertains without departing from its scope.

In some examples, the fabric controller monitors the health of an application being upgraded based on a set of health policies during the monitored rolling upgrade. When the application in an upgrade domain has been upgraded, the fabric controller evaluates the application health and the system health to determine whether to proceed to a next upgrade domain and continue the upgrade in the cluster, or to fail the upgrade based on the health results from the upgrade domain. The cluster manager enforces the health policies and provides them to the health manager for evaluation against health information received from applications and/or system components of an upgrade domain. If an application is healthy after an upgrade, or the upgrade is otherwise deemed successful, the cluster manager may use upgrade policies to determine a next step in the upgrade process. Health policies and upgrade policies may be specified per application by an administrator or a user, which may override default application policies in some examples. In other examples, health policies and/or upgrade policies may be specified on a per upgrade basis.

In an example scenario, the health manager persists health data at the health store. The health data may include health information from an application, health information from an instance of an application, health information from a system component, health information from a node, or any other suitable health information associated with a cluster. The health manager collects, collates, stores, and evaluates health information against health policies provided by the cluster manager, and provides health check results to the cluster manager. Computation of aggregated health state is performed by the health manager, which receives health telemetry data from both system components and user components.

In these examples, because the upgrade workflow of each application instance is driven independently, the system provides for multiple concurrent upgrades across different application instances and versions throughout a distributed system. The cluster manager combines the application upgrade state with health check results to drive the upgrade workflow through other system components responsible for hosting application instances.

Alternatively or in addition to the other examples described herein, examples include any combination of the following:
wherein the upgrade updates the application from an original version to a new version of the application;
performing an automatic rollback of the at least one instance of the application back to the original version of the application;
wherein the set of health policies is a first set of health policies;
receiving a second set of health policies;
continuing the upgrade of the upgrade domain;
performing a health check evaluation based on the health information for the at least one instance of the application and the second set of health policies to generate other health check results for the upgrade domain to determine if the upgrade is successful based on the second set of health policies;
determining whether a health check wait time is completed following completion of the upgrade;
in response to a determination that the health check wait time is completed, performing a health check on the upgrade domain to receive the health check results;
wherein monitoring the availability of the application during the upgrade further comprises performing a first health check on the upgrade domain;
determining whether a maximum health check retry timeout has been reached;
in response to a determination that the maximum health check retry timeout has not been reached, performing a second health check on the upgrade domain following completion of a health check wait time;
determining whether a maximum health check retry timeout period has completed;
in response to a determination that the maximum health check retry timeout period has completed, providing a failed status indicator for the upgrade;
in response to a determination that there is the second upgrade domain in the cluster of nodes, sending the upgrade request to the second upgrade domain;
performing a health check on the second upgrade domain following completion of a health check wait time;
receiving second health check results for the second upgrade domain;
evaluating the second health check results for the second upgrade domain to determine if the upgrade to the second upgrade domain is successful;
a health store configured to persist the health information and corresponding health policies as health data;
an upgrade domain of the cluster of nodes, the upgrade domain comprising a set of nodes from the cluster of nodes, wherein the upgrade domain receives an upgrade request from the cluster manager, the upgrade request associated with an application hosted by the set of nodes of the upgrade domain;
wherein the application associated with the upgrade request from the cluster manager is upgraded within the upgrade domain, and wherein the upgrade domain sends health information corresponding to at least one of the application and the set of nodes to a health manager;
wherein the health information received by the health manager from the upgrade domain is evaluated against the provided health policies from the cluster manager to generate health check results;
wherein the analysis of the health check results determines whether the application upgrade is a success or a failure;
on determining the health check results indicate the application upgrade was a success, initiating an application upgrade of a next upgrade domain;
on determining the health check results indicate the application upgrade was a failure, performing a rollback of the application to the first version of the application;
wherein the health check of the upgrade domain is initiated after a health check wait time passes following completion of the update;
wherein the analysis of the received health check results indicate an upgrade failure;
on condition a maximum health check retry time has not been reached, performing a second health check on the upgrade domain after the health check wait time is passed;
wherein the second version of the application is an intermediate version that is compatible with the first version of the application and a third version of the application;
wherein the analysis of the received health check results indicate an upgrade failure, wherein performing the upgrade action comprises indicating an upgrade failure;
receiving a second set of health policies;
continuing the upgrade of the upgrade domain;
initiating a second health check of the upgrade domain to receive second health check results for the upgrade domain based on evaluating the received health information against the second set of health policies;
wherein the second set of health policies are generated by a user dynamically during the application upgrade

In some examples, the operations illustrated in FIG. 7, FIG. 8, and FIG. 9 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

While no personally identifiable information is tracked by aspects of the disclosure, examples have been described with reference to data monitored and/or collected from applications or application instances, which may include user interaction data. In some examples, notice may be provided to the users of the collection of the data (e.g., via a dialog box or preference setting) and users may be given the opportunity to give or deny consent for the monitoring and/or collection. The consent may take the form of opt-in consent or opt-out consent.

The examples illustrated and described herein as well as examples not specifically described herein but within the scope of aspects of the disclosure constitute exemplary means for monitored application upgrades. For example, the elements illustrated in FIG. 3, such as when encoded to perform the operations illustrated in FIGS. 7-9, constitute exemplary means for requesting an application upgrade, exemplary means for receiving health information associated with the application upgrade, and exemplary means for determining the success or failure of the application upgrade based on health policies and upgrade policies.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A method for monitored upgrades of a cluster, the method comprising:
sending, by a cluster manager implemented on at least one processor, an upgrade request to a first upgrade domain for upgrade of an application, the first upgrade domain comprising a set of nodes from a cluster of nodes, the first upgrade domain hosting at least one instance of the application;
monitoring availability of the application during the upgrade;
receiving health check results for the first upgrade domain from a health manager, the health manager generating the health check results based on health information received from the first upgrade domain and a set of health policies provided by the cluster manager;
determining whether the upgrade is successful based on the health check results;
in response to a determination that the upgrade is successful, determining whether there is a second upgrade domain in the cluster of nodes, wherein the upgrade request is rolled out to individual upgrade domains in the cluster of nodes until the cluster is upgraded; and
in response to a determination that the upgrade is not successful, performing an upgrade failure action.

2. The method of claim 1, wherein the upgrade updates the at least one instance of the application from an original version to a new version, and wherein performing the upgrade failure action further comprises:
performing an automatic rollback of the at least one instance of the application back to the original version of the application.

3. The method of claim 1, wherein the set of health policies is a first set of health policies, and wherein performing the failure action further comprises:
receiving a second set of health policies;
continuing the upgrade of the first upgrade domain; and
performing a health check evaluation based on the health information for the at least one instance of the application and the second set of health policies to generate other health check results for the first upgrade domain to determine if the upgrade is successful based on the second set of health policies.

4. The method of claim 1, wherein monitoring the availability of the application during the upgrade further comprises:
determining whether a health check wait time is completed following completion of the upgrade; and
in response to a determination that the health check wait time is completed, performing a health check on the first upgrade domain to receive the health check results.

5. The method of claim 1, wherein monitoring the availability of the application during the upgrade further comprises performing a first health check on the first upgrade domain, and wherein performing the upgrade failure action further comprises:
determining whether a maximum health check retry timeout is reached;
in response to a determination that the maximum health check retry timeout is not reached, performing a second health check on the first upgrade domain following completion of a health check wait time.

6. The method of claim 1, wherein performing the upgrade failure action further comprises:
determining whether a maximum health check retry timeout period has completed; and
in response to a determination that the maximum health check retry timeout period has completed, providing a failed status indicator for the upgrade.

7. The method of claim 1, further comprising:
in response to a determination that there is the second upgrade domain in the cluster of nodes, sending the upgrade request to the second upgrade domain;
performing a health check on the second upgrade domain following completion of a health check wait time;
receiving second health check results for the second upgrade domain; and
evaluating the second health check results for the second upgrade domain to determine if the upgrade to the second upgrade domain is successful.

8. A system for monitored upgrades using health information, the system comprising:
a fabric controller hosting a cluster of nodes;
a cluster manager implemented on the fabric controller and configured to manage the cluster of nodes and provide health policies and upgrade policies for the cluster of nodes;
a health manager implemented on the fabric controller and communicatively coupled to the cluster manager, the health manager configured to receive health information from the cluster of nodes and provide health check results to the cluster manager based on the provided health policies, the health check results used by the cluster manager to determine a success of an upgrade request.

9. The system of claim 8, further comprising:
a health store configured to persist the health information and corresponding health policies as health data.

10. The system of claim 8, further comprising:
an upgrade domain of the cluster of nodes, the upgrade domain comprising a set of nodes from the cluster of nodes, wherein the upgrade domain receives an upgrade request from the cluster manager, the upgrade request associated with an application hosted by the set of nodes of the upgrade domain.

11. The system of claim 10, wherein the application associated with the upgrade request from the cluster manager is upgraded within the upgrade domain, and wherein the upgrade domain sends health information corresponding to at least one of the application and the set of nodes to a health manager.

12. The system of claim 11, wherein the health information received by the health manager from the upgrade domain is evaluated against the provided health policies from the cluster manager to generate health check results.

13. One or more computer storage media having computer-executable instructions embodied thereon that, on execution by a computer, cause the computer to perform operations, comprising:
a cluster manager for:
initiating an application upgrade on a first upgrade domain, the first upgrade domain comprising an application associated with a first version of the application;
performing the application upgrade on the first upgrade domain, including upgrading the first version of the application to a second version of the application;
on completion of the application upgrade, initiating a health check of the first upgrade domain to receive health check results from a health manager for the first upgrade domain, the health check results based on an evaluation of health information received from the application and system components of the first upgrade domain against a set of policies for the application; and
automatically performing an upgrade action based on an analysis of the received health check results for the first upgrade domain.

14. The one or more computer storage media of claim 13, wherein the analysis by the cluster manager of the health check results determines whether the application upgrade is a success or a failure, and further comprising:
on determining the health check results indicate the application upgrade was a success, the cluster manager initiating an application upgrade of a next upgrade domain.

15. The one or more computer storage media of claim 14, further comprising:
on determining the health check results indicate the application upgrade was a failure, the cluster manager performing a rollback of the application on the first upgrade domain to the first version of the application.

16. The one or more computer storage media of claim 13, wherein the health check of the first upgrade domain is initiated after a health check wait time passes following completion of the update.

17. The one or more computer storage media of claim 16, wherein the analysis by the cluster manager of the received health check results indicate an upgrade failure, and further comprising:
on condition a maximum health check retry time is not reached, the cluster manager performing a second health check on the first upgrade domain after the health check wait time is passed.

18. The one or more computer storage media of claim 13, wherein the second version of the application is an intermediate version that is compatible with the first version of the application and a third version of the application.

19. The one or more computer storage media of claim 13, wherein the analysis by the cluster manager of the received health check results indicate an upgrade failure, wherein performing the upgrade action comprises indicating an upgrade failure, and further comprising:
receiving a second set of health policies;
continuing the upgrade of the first upgrade domain; and
initiating a second health check of the first upgrade domain to receive second health check results for the first upgrade domain based on evaluating the received health information against the second set of health policies.

20. The one or more computer storage media of claim 19, wherein the second set of health policies are dynamically generated during the application upgrade.
